(19) United States
(12) Patent Application Publication
(10) Pub. No.: US 2007/0199235 A1
(43) Pub. Date: Aug. 30, 2007

(54) Fishing Sinker Combined Bait Case

(76) Inventor: Sung Ho Yu, Busan (KR)

Correspondence Address: OSHA LIANG L.L.P., 1221 MCKINNEY STREET, SUITE 2800, HOUSTON, TX, 77010, US

(21) Appl. No.: 10/592,897

(22) PCT Filed: Mar. 16, 2005
(86) PCT No.: PCT/KR05/00757

§ 371 Date: Sep. 15, 2006

(30) Foreign Application Priority Data
Mar. 16, 2004 (KR) 20--2004-0007173

(51) Int. Cl. A01K 97/02; A01K 95/00

(52) U.S. Cl. 43/44.99; 43/43.1; 43/44.9; 43/44.91

(57) ABSTRACT

A fishing sinker combined with a bait case is disclosed. The fishing sinker includes a lower cap whose body forms a plurality of through-holes, and an upper cap whose body forms a plurality of through-holes, in which the upper cap is assembled on the upper surface of the lower cap. The lower cap has a bolt insertion hole on the lower surface thereof. The upper cap forms a nut insertion hole on the upper surface thereof. A bolt is passed through the bolt insertion hole, and then the nut insertion hole such that one end of the bolt is protruded from the nut insertion hole, in which the one end of the bolt forms a thread on the outer surface thereof and the bolt forms a through-hole in its length direction, through which a fishing line is passed. A nut is tightened to the one end of the bolt, such that the upper cap and the lower cap can be fastened to one another. The fishing sinker combined with a bait case has advantages in that, since the bait case can contain the ground baits in order to attract fish, anglers do not need to scatter the ground baits on the water and the ground baits do not cause water pollution, thereby being pro-environments. Also, the bait case can contain relatively small stone, such as a pebble, and a lump of yellow soil, etc, performing a function as a sinker. Therefore, the fishing sinker combined with a bait case according to the present invention can be conveniently used.

### TECHNICAL FIELD

The present invention relates to a fishing sinker, and more particularly, to a fishing sinker combined with a bait case which is capable of containing baits, etc., for attracting fish, and performing its inherent function that sinks fishing hooks into water.

### BACKGROUND ART

When fishing, anglers generally scatter ground baits on the water within a predetermined area where fishing hooks are sunk in order to attract fish. For this, the anglers crash baits at smaller size and frequently scatter the crashed baits on the water around the fishing hooks while they are fishing.

On the other hand, fishing sinkers sink fishing hooks into water. Such fishing sinkers are mostly made of lead, and manufactured in various shapes and sizes. Therefore, the shapes and sizes of the fishing sinkers are selected according to kinds of fishing, such as freshwater fishing and sea fishing.

As such, even though such a ground bait scattering method is a general method for gathering fish in a predetermined area where the ground bait are scattered, the ground baits thrown into water causes water pollution in the fishing spot. In addition, the fishing sinkers made of lead are frequently and easily lost into the water, which causes water pollution in the fishing spot. On the other hand, since the prior art fishing sinkers are fixedly made in their sizes and weights, the fishing sinkers must change their sizes and weights according to kinds of floats and fishing hooks.

In order to resolve such problems, there has been proposed a bait imbedded fishing hook (Japanese Utility Model Publication No. S53-087292, filed on Jul. 18, 1978), which is capable of containing ground baits therein and performing its inherent function as a sinker.

Such a bait imbedded fishing hook includes a bait case, which has a lower cap whose body forms a plurality of through-holes therein, and an upper cap whose body forms a plurality of through-holes therein, in which the upper cap is assembled to the upper surface of the lower cap, and elastic wires installed to the upper and lower sides of the bait basket. Here, each of the elastic wires attaches a fishing swivel thereto.

Although the prior art bait imbedded fishing sinker has an advantage in that it can contains ground baits in its bait case to attract fish and thus does not causes water pollution, however, since the bait case attaches the elastic wires to the upper and lower side thereof, in which each of the elastic wires couples to the fishing swivel, in the case that the fishing swivel is connected to a fishing hook, biting of fish is directly transmitted to the bait case. Therefore, the angler has difficulty that he cannot feel the biting of fish.

Also, since the prior art bait case is designed to allow a fishing line to pass therethrough, the ground bait in the bait basket causes a problem that the angler cannot feel biting of fish.

### DISCLOSURE OF THE INVENTION

Technical Problem

Therefore, the present invention has been made in view of the above problems, and it is an object of the present invention to provide a fishing sinker combined with a bait case which is capable of containing ground baits so as not to be sunk into the bottom of water in order to attract fish, thereby being pro-environments, of performing its inherent function as a sinker, and of allowing a float to be easily adjusted, in which the fishing sinker combined with a bait case is not made of lead.

Technical Solution

In accordance with an aspect of the present invention, the above and other objects can be accomplished by the provision of a fishing sinker combined with a bait case including a lower cap whose body forms a plurality of through-holes, and an upper cap whose body forms a plurality of through-holes, in which the upper cap is assembled to the upper surface of the lower cap. The lower cap has a bolt insertion hole on the lower surface thereof. The upper cap forms a nut insertion hole on the upper surface thereof. A bolt is passed through the bolt insertion hole, and then the nut insertion hole such that one end of the bolt is protruded from the nut insertion hole, in which the one end of the bolt forms a thread on the outer surface thereof and the bolt forms a through-hole in its length direction, through which a fishing line is passed. A nut is tightened to the one end of the bolt, such that the upper cap and the lower cap can be fastened to one another.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a fishing sinker combined with a bait case according to the present invention; and

FIG. 2 is a cross-sectional view illustrating a fishing sinker combined with a bait case according to the present invention, which is in an assembled state.

### BEST MODE FOR CARRYING OUT THE INVENTION

Referring to the attached drawings, the preferred embodiment of the present invention is described in detail below.

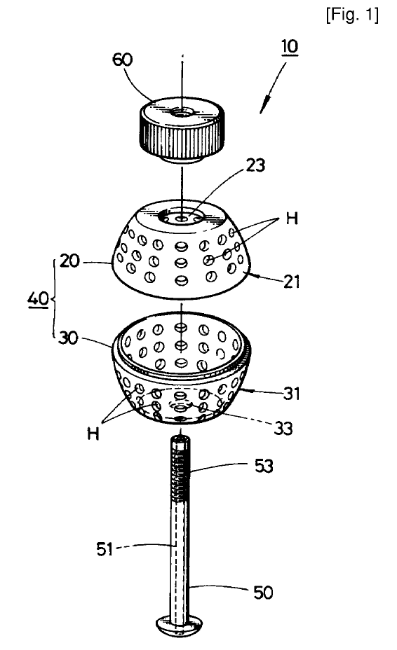

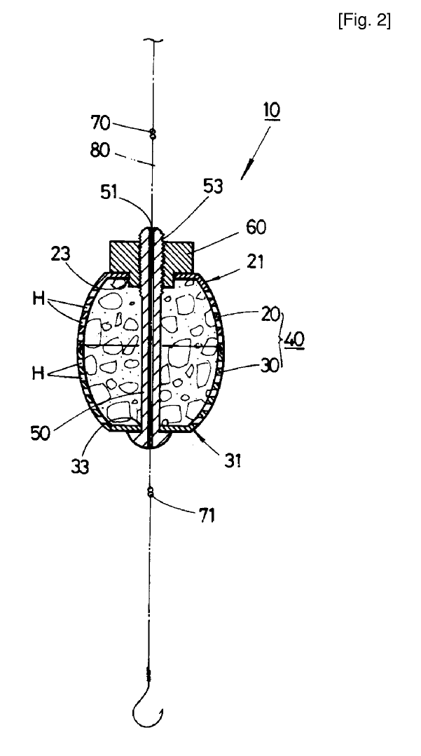

FIG. 1 is an exploded perspective view illustrating a fishing sinker combined with a bait case according to the present invention, and FIG. 2 is a cross-sectional view illustrating a fishing sinker combined with a bait case according to the present invention, which is in an assembled state.

As shown in the drawings, the fishing sinker combined with a bait case 10 according to the present invention includes an upper cap 20, a lower cap 30, and a bolt 50 and nut 60 which are coupling the upper cap 20 to the lower cap 30.

The lower cap 30 is designed such that a lower cap body 31 forms a bolt insertion hole 33 on the lower surface thereof and a plurality of through-holes H on the outer surface thereof.

The upper cap 20 is designed such that an upper cap body 21 forms a nut insertion hole 23 on the upper surface thereof and a plurality of through-holes H on the outer surface thereof. Here, the through-holes formed on each outer surface of the lower and upper cap bodies 31 and 21 are denoted by a notation symbol “H”.

On the other hand, the upper cap body 21 and the lower cap body 31 are coupled to one another, and then the bolt 50 passed through the bolt insertion hole 33 is tightened up with the nut 60 mounted on the nut insertion hole 23, such that a bait case 40 composed of the upper and lower caps 20 and 30 is assembled. The bait case 40 is dissembled into the upper and lower caps 20 and 30 as the bolt 50 and the nut 60 are loosed. Therefore, the bait case 40 can be assembled or dissembled as the bolt 50 and the nut 60 are tightened or loosed. Here, the bolt 50 is designed such that a through-hole 51, through which a fishing line 80 is passed, is formed therein in its length direction and a thread 53 corresponding to that of the nut 60 is formed at one end on the outer surface thereof.

As such, the fishing sinker combined with a bait case 10 according to the present invention is located along the fishing line 80 and between the swivels 70 and 71, as the fishing line 80 is passed through the through-hole 51 for a fishing line. Therefore, the fishing line 80 is not locked by the ground bait, instead it can easily transmit biting of fish to an angler.

When an angler tries to put ground baits, etc., into the bait case 40, the bolt 50 is loosed from the nut 60 of the bait case 40 until the upper and the lower caps 20 and 30 are separated from one another. If the upper and the lower caps 20 and 30 are separated, the ground baits are inserted in the upper and the lower caps 20 and 30. After that, the upper and the lower caps 20 and 30 are coupled to one another and then fastened as the bolt 50 and the nut 60 are tightened until the upper and the lower caps 20 and 30 are fixed to one another.

Therefore, such a bait case 40 can contain the ground baits therein in order to attract fish. Also, the bait case 40 including the upper and the lower caps 20 and 30 can perform a function as a sinker. Here, the total weight of the bait case 40 functioning a sinker can be properly determined. Namely, the weight of the bait case 40 is determined by ground baits, or relatively small stone, such as a pebble, and a lump of yellow soil, etc, which are capable of being contained therein, such that the location of the float can be adjusted on the fishing line.

On the other hand, the ground baits in the bait case 40 are soluble in water and diffused into the water through the through-holes H formed on the outer surfaces of the upper and lower cap bodies 21 and 31, thereby attracting fish.

### INDUSTRIAL APPLICABILITY

As mentioned above, the fishing sinker combined with a bait case according to the present invention has advantages in that, since the bait case can contain the ground baits in order to attract fish, anglers do not need to scatter the ground baits on the water and the ground baits do not cause water pollution, thereby being pro-environments. Also, the bait case can contain relatively small stone, such as a pebble, and a lump of yellow soil, etc, performing a function as a sinker. In addition, since the fishing line is not locked by the ground baits, the anglers can easily feel fine biting of fish. Therefore, the fishing sinker combined with a bait case according to the present invention can be conveniently used.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fishing sinker combined with a bait case including a lower cap whose body forms a plurality of through-holes, and an upper cap whose body forms a plurality of through-holes, in which the upper cap is assembled on the upper surface of the lower cap, wherein:
the lower cap has an bolt insertion hole on the lower surface thereof;
the upper cap forms a nut insertion hole on the upper surface thereof;
a bolt is passed through the bolt insertion hole, and then the nut insertion hole such that one end of the bolt is protruded from the nut insertion hole, in which the one end of the bolt forms a thread on the outer surface thereof and the bolt forms a through-hole in its length direction, through which a fishing line is passed; and
a nut is tightened to the one end of the bolt, such that the upper cap and the lower cap can be fastened to one another.
